(19) United States
(12) Patent Application Publication
(10) Pub. No.: US 2006/0208620 A1
(43) Pub. Date: Sep. 21, 2006

(54) Image display device and production method for same

(76) Inventors: Takahiko Muneyoshi, Musashimurayama (JP); Nobuaki Hayashi, Kunitachi (JP); Susumu Sasaki, Chiba (JP); Makoto Okai, Tokorozawa (JP); Tomio Yaguchi, Sagamihara (JP); Tetsuya Yamazaki, Fujisawa (JP); Jun Ishikawa, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/376,193

(22) Filed: Mar. 16, 2006

(30) Foreign Application Priority Data
Mar. 17, 2005 (JP) 2005-076876

(51) Int. Cl. H01J 63/04; H01J 1/00; H01J 19/06

(52) U.S. Cl. 313/311; 313/495

(57) ABSTRACT

An image display device in which a damage which is imparted to carbon nanotubes is small and electron emission characteristics are favorable and a production method thereof are provided. A printed film 6 having carbon nanotubes 3, a resin 4 and a carbon component 5 is formed on a cathode electrode 2 of a glass substrate 1 and, then, by irradiating laser having a short pulse and high output in an ultraviolet region on the thus-formed printed film 6, the resin 4 is thermally decomposed and evaporated and, thereafter, by an impact generated at that time, binding between carbon nanotubes 3 themselves in the vicinity of a surface of the printed film 6 is severed and, at the same time, the carbon nanotubes 3 come to be in a state of being raised on the surface of the printed film 6.

### CLAIM OF PRIORITY

The present application claims priority from Japanese application serial no. 2005-076876, filed on Mar. 17, 2005, the content of which is hereby incorporated by reference into this application.

### BACKGROUND OF THE INVENTION

The present invention relates to a display device which utilizes emission of an electron into vacuum and a production method therefor. Particularly, the present invention relates to an image display device having an electron source containing carbon nanotubes and a method for producing the image display device.

In recent years, a development of a thin-shaped image display device which performs display by exciting phosphors with a multiple of electron beams has extensively been conducted. A carbon nanotube in which a six-membered cyclic net of carbon atoms has a cylindrical shape has attracted people's attention as an electron source to be used in the image display device. In order to use the carbon nanotube as the electron source of the image display device, a method in which a viscous solution is produced by mixing the carbon nanotube and any one of organic binders with each other and, then, the thus-produced viscous solution is printed by using a screen printing method, dried and baked and, thereafter, the resultant electron source containing the carbon nanotube is disposed in a desired position has frequently been used. On this occasion, on a surface of the electron source after subjected to baking, carbon nanotubes are firmly bound with each other by cured materials of organic binders or the like and, even when an electric field is applied thereto, tips of the carbon nanotubes are not charged with the electric field and, accordingly, electrons can not be emitted from the carbon nanotubes.

Then, as described in Preprints of the 50th Joint Meeting of the Japan Society of Applied Physics and Related Societies, Vol. 2, p. 1025 (Lecture No. 28p-W-8), a method in which binding between carbon nanotubes themselves is severed by irradiating laser having a short pulse and high output on a surface of an electron source containing the carbon nanotubes formed by using a screen printing method and, then, an electric field is allowed to be charged on the carbon nanotubes is proposed.

Next, the above-described method is described in detail with reference to the accompanying drawings.

FIG. 8 is an enlarged cross-sectional view of an essential portion of a conventional electron source subjected to printing and baking. In FIG. 8, a printed film 7 formed, by performing printing and baking, on a cathode electrode 2 formed on a glass substrate 1 contains carbon nanotubes 3 and a carbon component 5 which is produced by curing an organic binder through heat-baking. The carbon nanotubes 3 are firmly bound with each other by a van der Waals' force, the carbon component 5 or the like and are shaped such that an electric field is not concentrated on tips of the carbon nanotubes 3. For this reason, even when the electric field is applied thereto, electrons are not emitted from the carbon nanotubes 3.

When the laser having a short pulse and high output is irradiated on the carbon nanotubes 3, as shown in an enlarged cross-sectional view of an essential portion of FIG. 9, binding between the carbon nanotubes 3 themselves is severed and, further, the carbon nanotubes 3 come to be in a state of being exposed on the surface of the printed film 7. This is because, when the laser having the short pulse and high output is irradiated, a temperature of the surface of the printed film 7 is instantaneously raised and, then, reaches a vaporizing temperature thereof. Under these circumstances, as shown in FIG. 9, the binding between the carbon nanotubes 3 themselves is severed and, simultaneously, the carbon nanotubes 3 come to be exposed on the surface of the printed film 7. For this account, the electric field can be concentrated on the tips of the carbon nanotubes 3 and, then, the electrons can be emitted.

### SUMMARY OF THE INVENTION

In the electron source constituted in such a manner as described above, the binding between the carbon nanotubes is severed by the irradiation of the laser having the short pulse and high output, to thereby increase the number of emission sites. Thus, an amount of emission current is larger than that before the laser having the short pulse and high output is irradiated.

However, on this occasion, at the time the binding between the carbon nanotubes 3 themselves is severed by the irradiation of the laser having the short pulse and high output, the carbon nanotubes 3 themselves are damaged. For this account, there is a problem in that emission characteristics and life time of the electron source containing the carbon nanotubes 3 are extremely deteriorated compared with the emission characteristics and the life time which original carbon nanotubes have.

The present invention has been made for solving such conventional problems as described above and has an object to provide an image display device capable of realizing an electron source having a long lifetime and favorable emission characteristics and a method for producing the image display device.

In order to attain the object, in the image display device according to the invention, by allowing a polymer having at least an aromatic ring, a carbonyl group and nitrogen in a main chain thereof to be contained in the electron source containing the carbon nanotubes, when the laser having the short pulse and high output is irradiated on the electron source, the laser is allowed to be absorbed by the polymer on a priority base and, simultaneously, the polymer can be instantaneously decomposed and evaporated. On this occasion, a kind of explosion occurs, to thereby sever the binding between carbon nanotubes themselves. As a result, the number of the emission sites can be increased, to thereby enhance emission characteristics. By an impact generated at the time the polymer is decompose-evaporated, the carbon nanotubes come to be in a state of being raised on the surface of the electron source, to thereby generate a state in which the electric field is easily charged.

Further, as for the polymer containing at least an aromatic ring, a carbonyl group and nitrogen, a polymer having a phenyl carbamic acid ester structure or a polymer containing a benzomaleimide structure is appropriate. Polyurethane containing the phenyl carbamic acid ester structure or a polyimide containing the benzomaleimide structure is low in cost and easily available in the market and, since it can not only easily be processed into various types of shapes but also secure heat resistance, it is appropriate to be contained in the electron source containing the carbon nanotubes. Still further, since the aromatic ring has a high index of absorption of light in an ultraviolet region, by allowing a wavelength of the laser to be that of ultraviolet light, the polymer can more efficiently be decompose-evaporated.

According to the invention, since an electron source contains a polymer containing at least an aromatic ring, a carbonyl group and nitrogen in a main chain and a group of carbon nanotubes and, then, at least one portion of the group of the carbon nanotubes is formed in a state of being raised on a surface of the electron source, an electric field can more easily be charged on tip portions of the carbon nanotubes and, therefore, an extremely favorable effect can be obtained such that electron emission characteristics can be enhanced.

Further, according to the invention, by mixing polyurethane having a phenyl carbamic acid ester structure or polyimide having a benzomaleimide structure in a printed film containing carbon nanotubes, at the time binding between carbon nanotubes themselves is severed by using laser having a short pulse and high output in an ultraviolet region, a damage which is imparted to the carbon nanotubes themselves can be small and, therefore, an extremely favorable effect can be realized such that an image display device having favorable electron emission characteristics can be obtained.

### BRIEF DESCRIPTION OF THE DRAWINGS

FIG. 1 is an enlarged cross-sectional view of an essential portion of a carbon nanotube electron source in a rear substrate prepared by printing and, then, baking a carbon nanotube material of a first embodiment of an image display device according to the present invention;

FIG. 2 is an enlarged cross-sectional view of an essential portion of a carbon nanotube electron source in a rear substrate prepared by irradiating laser having a short pulse and high output in an ultraviolet ray region after the carbon nanotube material shown in FIG. 1 is printed and, then, baked;

FIG. 3 is a view for explaining electron emission characteristics of the carbon nanotube electron source of the first embodiment according to the present invention;

FIG. 4 is an enlarged perspective view of an essential portion showing an example of a schematic constitution of an image display device according to the present invention;

FIG. 5 is a cross-sectional view taken along a line A-A′ in FIG. 4;

FIG. 6 is a partial cutaway view showing an example of an entire structure of an image display device according to the present invention;

FIG. 7 is a cross-sectional view taken along a line B-B′ in FIG. 6;

FIG. 8 is an enlarged cross-sectional view of an essential portion showing a printed film of a carbon nanotube material in a conventional example; and

FIG. 9 is an enlarged cross-sectional view of an essential portion showing a printed film of a carbon nanotube material in a conventional example.

### DESCRIPTION OF THE PREFERRED EMBODIMENTS

Hereinafter, the invention is now described in detail with reference to the preferred embodiments shown in the accompanying drawings. Same numerals or signs in figures indicate a same member or a comparable member. Specific sizes used for explaining the embodiments are illustrative and the present invention is not limited thereto.

### EXAMPLE 1

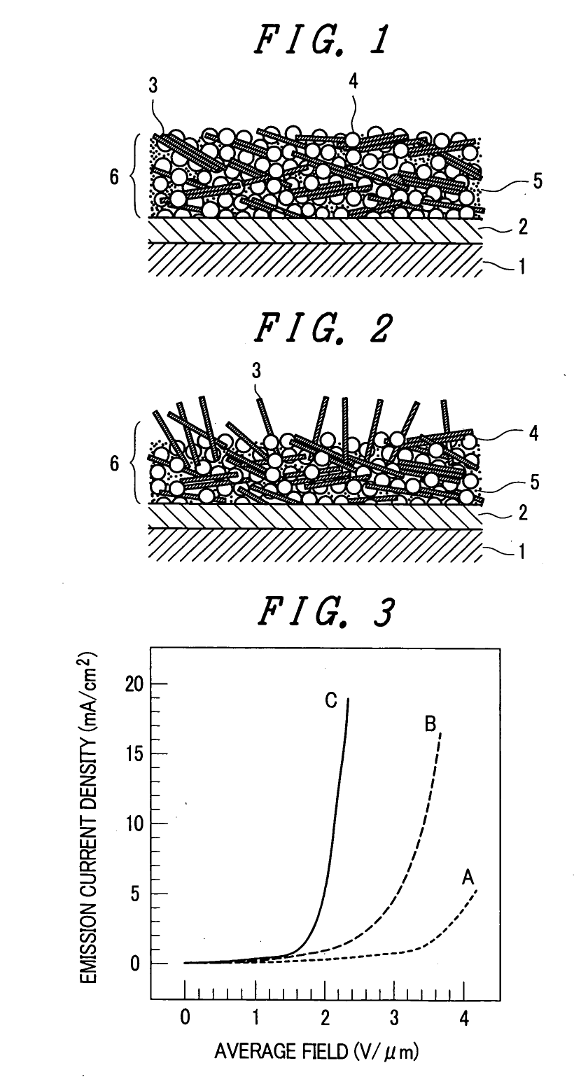

FIG. 1 is an enlarged cross-sectional view of an essential portion which schematically shows a constitution of an electron source of a first embodiment of an image display device according to the present invention and shows a cross-section of a printed film after printing and baking are performed. In FIG. 1, the printed film 6 is formed on a glass substrate 1 and a cathode electrode 2 and contains carbon nanotubes 3, a resin 4 and a carbon component 5. The resin 4 is a polymer having a phenyl carbamic acid ester structure as shown in the following formula (1) or a benzomaleimide structure as shown in the following formula (2):

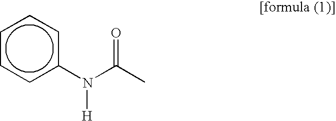

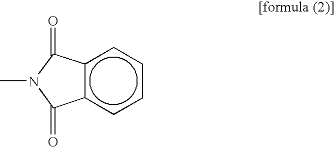

The phenyl carbamic acid ester structure as shown in the formula (1) and the benzomaleimide structure as shown in the following formula (2) have characteristics of easily absorbing light in an ultraviolet region. Therefore, when laser having a short pulse and high output in the ultraviolet region is irradiated on the resin 4, the ultraviolet light is absorbed by the resin 4 and changed into heat, to thereby instantaneously decompose and evaporate the resin 4.

FIG. 2 is an enlarged cross-sectional view of an essential portion which schematically shows a state after laser having a short pulse and high output in an ultraviolet ray region is irradiated on a printed film 6. In FIG. 2, the resin 4 in the vicinity of a surface of the printed film 6 is instantaneously evaporated by an irradiation of the laser having the short pulse and high output in the ultraviolet region and, then, an impact generated at this time not only severs binding between carbon nanotubes 3 themselves in the vicinity of the surface of the printed film 6 but also allows the carbon nanotubes 3 to be in a state of being raised on the surface of the printed film 6.

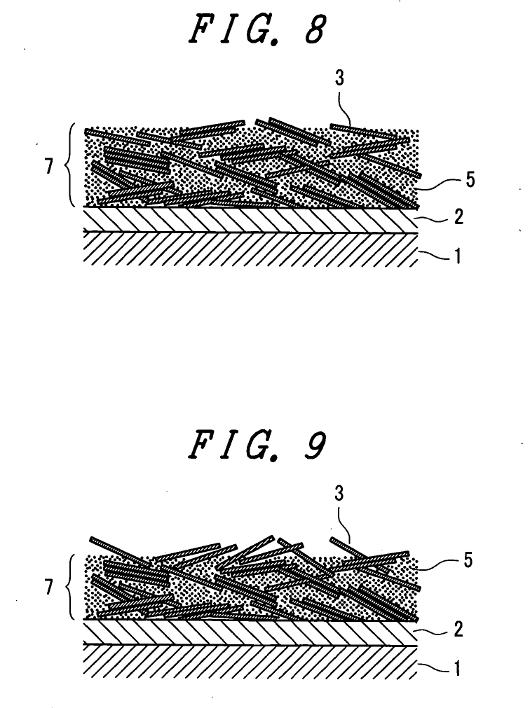

FIG. 3 shows a state of changes of electron emission characteristics of the printed film 6 before and after it is subjected to irradiations of laser having a short pulse and high output. The electron emission characteristics shows relation between an average field (V/μm) and an emission current density (mA/cm²). The average field (Vμm) is applied between a cathode and a control electrode, and the emission current density (mA/cm²) is emitted by an electron source formed on the cathode. A characteristic curve A in FIG. 3 shows electron emission characteristics of an electron source before it is subjected to an irradiation of laser having a short pulse and high output. In this, there is scarcely difference between characteristics of a conventional printed film 7 according to FIGS. 8 and 9 which does not contain a polymer 4 and those of the printed film 6 according to the invention which contains the polymer 4.

A characteristic curb B in FIG. 3 shows electron emission characteristics of a conventional printed film 7 which does not contain a resin 4 after it is subjected to an irradiation of laser having a short pulse and high output. It is found that, when the characteristic curb B is compared with the characteristic curb A which is before the irradiation, the electron emission characteristics thereof have been improved. A characteristic curb C in FIG. 3 shows electron emission characteristics of the printed film 6 according to the invention which contains a resin 4 after it is subjected to an irradiation of laser having a short pulse and high output. It is found that, when the characteristic curb C is compared with the characteristic curb A which is before the irradiation, the electron emission characteristics thereof have been improved to a great extent and have better characteristics than the characteristic curb B.

In FIG. 3, the reason why the electron emission characteristics of the characteristic curb C of the printed film 6 which contains the resin 4 are better than the electron emission characteristics of the characteristic curb B of the printed film 7 which does not contain the resin 4 is that damages which are imparted to the carbon nanotubes 3 by irradiation of laser are different from each other depending on the characteristic curbs. In a case of the printed film 7 which does not contain the resin 4, in order to sever the binding between the carbon nanotubes 3 themselves, such irradiated laser light is changed into heat by being absorbed by the carbon nanotubes 3 and the vicinity thereof, to thereby cause an evaporation action of the carbon nanotubes 3 and carbon components 5 of the vicinity thereof.

On this occasion, a heat energy of such absorbed laser light not only severs the binding between the carbon nanotubes 3 themselves but also deteriorates the carbon nanotubes 3 themselves. On the other hand, in a case of the printed film 6 which contains the resin 4, after the resin 4 efficiently absorbs the irradiated laser light, the resin 4 is evaporated, to thereby sever the binding between the carbon nanotubes 3 themselves. For this reason, the damage which is imparted to the carbon nanotubes 3 is extremely small, to thereby obtain favorable electron emission characteristics as shown in the characteristic curb C in FIG. 3.

As for resins each having a phenyl carbamic acid ester structure as shown in the formula (1), polyurethane as shown in the following formula (3) is mentioned and, further, as for resins each having a benzomaleimide structure as shown in the formula (2), polyimide as shown in the following formula (4) is mentioned, in which the polyurethane as shown in the formula (3) and the polyimide as shown in the formula (4) are low in cost and easy to be processed and are thermally resistant up to about 240° C. and about 350° C., respectively, in a non-oxidative atmosphere:

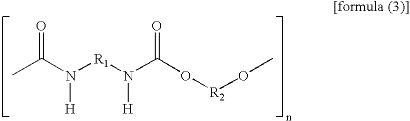

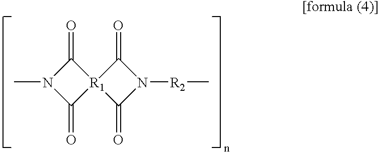

Next, a method for producing a printing paste which is a basis of the printed film 6 in FIG. 1, which comes to be an electron source and a method for forming the printed film 6 will be described in detail. First of all, the carbon nanotubes were crushed by using a ball mill, allowed to be dispersed in a dispersing agent containing a-terpineol and added with ethyl cellulose. The resultant dispersion was added with polyurethane particles of an average particle diameter of about 3 μm containing a phenyl carbamic acid ester structure as shown in the formula (1) or polyimide particles of an average particle diameter of about 3 μm containing a benzomaleimide structure as shown in the formula (2) and thoroughly mixed. On this occasion, a weight ratio of the polyurethane particles or polyimide particles against the carbon nanotubes was appropriately from about 1/5 to about 1/10. Further, the resultant mixture was added with a viscosity adjusting agent, to thereby adjust a viscosity thereof such that it came to be suitable for screen printing.

The thus-produced printing paste was printed on a cathode electrode 2 which had previously been formed on the glass substrate 1 by using a #325 mesh screen and dried by being heated for about 15 minutes at about 140° C. Then, when polyurethane having a phenyl carbamic acid ester structure was used as the resin 4, the thus-dried article was baked for about 30 minutes at about 240° C., whereas, when polyimide having a benzomaleimide structure was used as the resin 4, the thus-dried article was baked for about 30 minutes at about 350° C.

When the resultant printed film 6 was irradiated by KrF excimer laser (wavelength: 248 nm; pulse oscillation: about 20 ns) with an energy density of from about 50 mJ/cm² to about 250 mJ/cm², the resin 4 was instantaneously evaporated to cause a kind of explosion phenomenon. By this phenomenon, binding between the carbon nanotubes 3 themselves was severed, to thereby generate a state in which electric fields were concentrated on tips of the carbon nanotubes 3 as shown in the printed film 6 of FIG. 2. On this occasion, since the KrF excimer laser was more easily absorbed by the resin 4 than by the carbon nanotubes 3, the damage which was imparted to the carbon nanotubes 3 by the laser light was small. For this account, the electron emission characteristics which were superior compared with the case in which the resin 4 was not used was able to be obtained.

FIG. 4 is a perspective view of an essential portion showing a fundamental constitution of an image display device according to the invention. In FIG. 4, an anode panel 200 and a cathode panel 100 are joined with each other while keeping a substantially constant distance therebetween by placing a plurality of insulative spacers 301 therebetween. The anode panel 200 contains at least a glass substrate 201, a phosphor layer 202 and an anode 203. The phosphor layer 202 is divided into three color regions of red (R), green (G) and blue (B) in order to perform a color display and, then, three color regions are separated from one another by using black matrices (not shown).

The cathode panel 100 is provided with at least a cathode line 102, a control line 106 and an insulating layer 105 on a substrate 101. The cathode line 102 and the control line 106 are perpendicularly intersected with each other via the insulating layer 105. A pixel region 108 is provided at such intersection portion of the cathode line 102 and the control line 106.

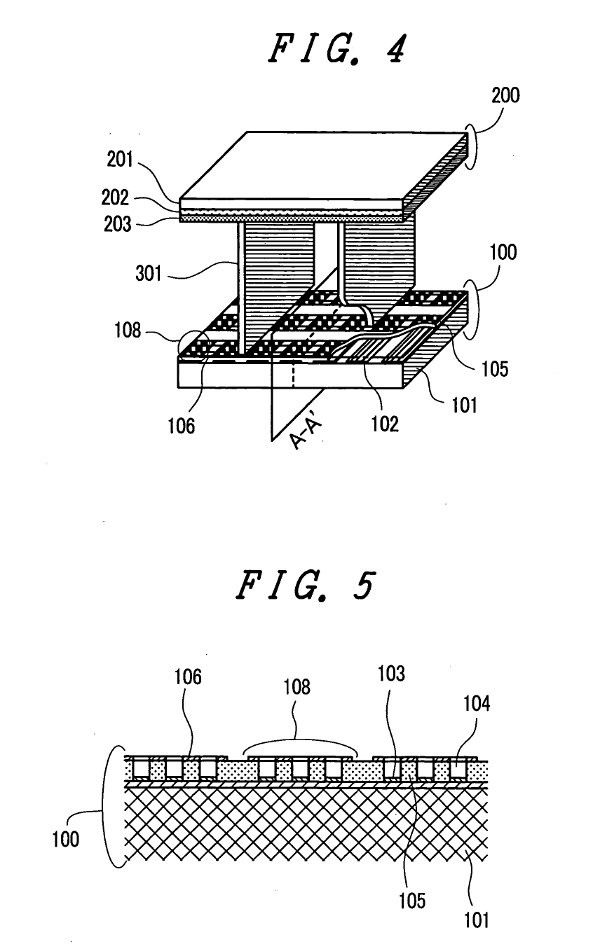

FIG. 5 is an enlarged cross-sectional view taken along a line A-A′, involving the pixel region 108, in FIG. 4. In FIG. 5, a plurality of openings 104 are provided in the pixel region 108 and, in each of the openings 104, an electrode source 103 is provided. The electrode source 103 is formed by irradiating laser, with a wavelength in an ultraviolet region, which has a short pulse and high output on a printed film of a carbon nanotube paste containing polyurethane particles each having a phenyl carbamic acid ester structure or polyimide particles each having a benzomaleimide structure as described in FIG. 2.

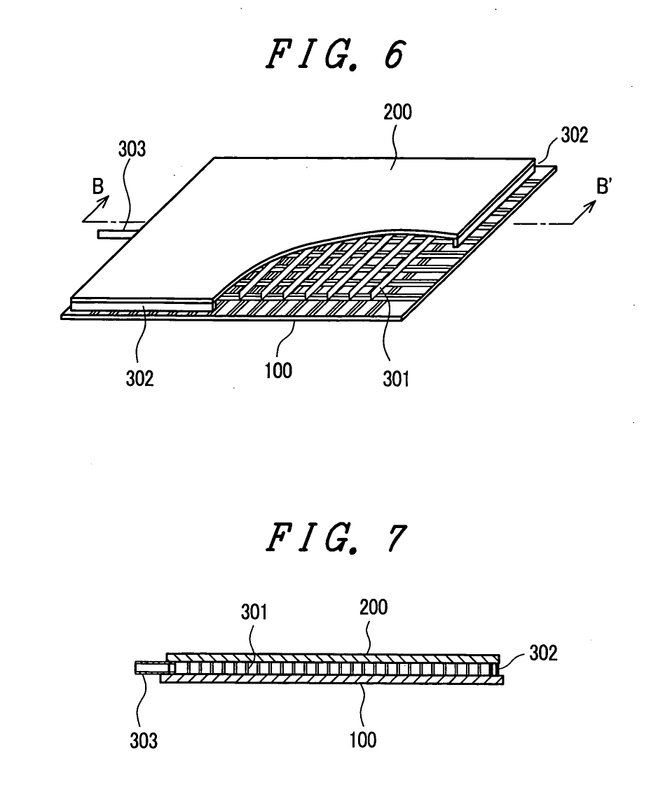

FIG. 6 is a perspective view of an essential portion showing an entire structure of an image display device; and FIG. 7 is a cross-sectional view taken along a line B-B′ in FIG. 6. The anode panel 200 and the cathode panel 100 are joined with each other while keeping a substantially constant distance therebetween by placing a plurality of insulative spacers 301 therebetween. Further, in order to keep a space between the anode panel 200 and the cathode panel 100 to be in vacuum, a frame glass 302 covers the periphery thereof and an exhaust pipe 303 is provided for discharging air existing therein.

Next, a method for producing the image display device according to the invention described in FIGS. 4 to 7 is described in detail. A silver paste is printed on the glass substrate 101 with a width of about 1200 μm and a distance pitch of about 1270 μm and, then, baked in an open air for about 20 minutes at about 550° C., to thereby form a cathode line 102. Thereafter, a paste containing the polyurethane particles of an average particle diameter of about 3 μm containing a phenyl carbamic acid ester structure or polyimide particles of an average particle diameter of about 3 μm containing a benzomaleimide structure and the carbon nanotubes is printed at a given position on the cathode line 102 from at which an electron is allowed to be emitted and, then, dried in an open air for about 30 minutes at about 150° C. Thereafter, when the polyurethane particles of an average particle diameter of about 3 μm containing a phenyl carbamic acid ester structure are used, the thus-dried substrate is baked for about 30 minutes at about 240° C. in an atmosphere of argon, whereas, when the polyimide particles of an average particle diameter of about 3 μm containing a benzomaleimide structure is used, the thus-dried substrate is baked for about 30 minutes at about 350° C. in an atmosphere of argon, to thereby form the electron source 103 having a thickness of about 15 μm.

Next, an insulative paste is printed in a given region on the cathode line 102 outside a region in which the electron source 103 is provided and, then, baked in an atmosphere of argon for about 20 minutes at about 450° C., to thereby form the insulative layer 105 of a thickness of about 30 μm. Thereafter, the silver paste is printed on the thus-formed insulative layer 105 with a width of about 400 μm and a distance pitch of about 423 μm in a direction perpendicular to the cathode line 102 and, then, baked in an atmosphere of argon mixed with about 0.2% of oxygen for about 15 minutes at about 450° C., to thereby form the control line 106. Subsequently, the KrF excimer laser (wavelength: about 248 nm; pulse oscillation: about 20 ns) is irradiated with an energy density of about 150 mJ/cm² while being focused on the electron source 103 on a bottom portion of the opening 104, instantaneously evaporates the resin 4 in the vicinity of the surface of the electron source 103 and severs the binding between the carbon nanotubes 3 themselves in the vicinity of the surface of the electron source 103, to thereby generate a state capable of emitting the electron from the carbon nanotubes 3. By using the above-described method, the cathode panel 100 can be produced.

Next, with reference to the anode panel 200, a black matrix (not shown), the phosphor layer 202 and the anode 203 were formed on the glass substrate 201 in same production steps as in a cathode-ray tube. Then, the spacer 301 was erected at a given position on the cathode panel 100 and, thereafter, the anode panel 200, the cathode panel 100 and the frame glass 302 are put in registry with respective appropriate positions and, then, joined with one another by using glass having a low melting point. Subsequently, an inside air is evacuated from the exhaust pipe 303 previously attached to the frame glass 302 down to about 100 μPa by using an oil diffusion pump while heating at about 200° C. and, then, the exhaust pipe 303 was sealed. By performing the above-described steps, a light-emission display device can be produced.

What is claimed is:

1. An image display device, comprising at least:
an electron source;
a cathode electrode for supplying electrons to the electron source;
a control electrode for controlling an amount of the electrons to be emitted from the electron source;
an anode electrode for accelerating the electrons to be emitted from the electron source; and
a phosphor which emits light by being excited with the electrons emitted from the electron source,
wherein the electron source having a polymer containing at least an aromatic ring, a carbonyl group and nitrogen in a main chain and a group of carbon nanotubes; and
at least one portion of the group of the carbon nanotubes is in a state of being raised on a surface of the electron source.

2. The image display device according to claim 1, wherein the polymer is a polymer containing a phenyl carbamic acid ester structure.

3. The image display device according to claim 1, wherein the polymer is polyurethane containing a phenyl carbamic acid ester structure.

4. The image display device according to claim 1, wherein the polymer is a polymer containing a benzomaleimide structure.

5. The image display device according to claim 1, wherein the polymer is polyimide containing a benzomaleimide structure.

6. A method for producing an image display device which comprises at least
an electron source having a polymer containing at least an aromatic ring, a carbonyl group and nitrogen in a main chain and a group of carbon nanotubes,
a cathode electrode for supplying electrons to the electron source,
a control electrode for controlling an amount of the electrons to be emitted from the electron source,
an anode electrode for accelerating the electrons to be emitted from the electron source, and
a phosphor which emits light by being excited with the electrons emitted from the electron source, comprising the steps of:
instantaneously evaporating at least one portion of the polymer by irradiating laser on a surface of the electron source; and
raising at least one portion of the group of the carbon nanotubes on a surface of the electron source.

7. The method for producing the image display device according to claim 6, wherein the laser is laser in an ultraviolet region.

8. The method for producing the image display device according to claim 6, wherein the polymer is a polymer containing a phenyl carbamic acid ester structure.

9. The method for producing the image display device according to claim 6, wherein the polymer is polyurethane containing a phenyl carbamic acid ester structure.

10. The method for producing the image display device according to claim 6, wherein the polymer is a polymer containing a benzomaleimide structure.

11. The method for producing an image display device according to claim 6, wherein the polymer is polyimide containing a benzomaleimide structure.
